(19) United States
(12) Patent Application Publication
(10) Pub. No.: US 2025/0292746 A1
(43) Pub. Date: Sep. 18, 2025

(54) Modular Guitar Body

(71) Applicant: Ian Williams, Menlo Park, CA (US)

(72) Inventor: Ian Williams, Menlo Park, CA (US)

(21) Appl. No.: 19/212,657

(22) Filed: May 19, 2025

Related U.S. Application Data
(63) Continuation-in-part of application No. 18/175,516, filed on Feb. 27, 2023, now abandoned.
Application No. 18/175,516 is a continuation-in-part of application No. 29/866,070, filed on Aug. 26, 2022, now Pat. No. D1046956.
Application No. 29/866,070 is a continuation-in-part of application No. 29/866,072, filed on Aug. 26, 2022, now Pat. No. D1046957.

(51) Int. Cl. G10D 1/08; G10H 3/18

(52) U.S. Cl. CPC G10D 1/085; G10H 3/181

(57) ABSTRACT

A modular guitar body. An outer body defines an open interior space. One or more inner body modules are configured for removable coupling of functional components within the open interior space of the outer body.

### BACKGROUND

This disclosure relates generally to musical instruments, and more particularly, to a modular guitar design. A modular instrument design can be desirable for ease of transport and for confidence in the integrity of the instrument when assembled.

### BRIEF DESCRIPTION OF THE DRAWINGS

FIG. 1 is a perspective view of a modular guitar in assembled form.

FIG. 2 is a perspective view of the outer body with inner body modules removed.

FIG. 3 is a perspective view of the outer body with inner body and control modules joined.

FIG. 4 is a side view of an exemplary inner body showing a connector for the pickups.

FIG. 5 is a side view of an exemplary control module showing a connector for the controls.

### DETAILED DESCRIPTION

In this description, an instrument is deconstructed into modules, such that a simple recoupling of the modules enables the features and functions associated with the instrument. For example, a wide variety of electric guitars are available in different shapes and sizes, but the basic elements and functionality are the same: a body; a neck coupled to the body; electronic pickups; and controls for the electronic pickups. Thus, the descriptions below really have broad applicability to any type of electronic stringed instrument. Further, the examples described below and shown in the drawings are merely illustrative and not limiting.

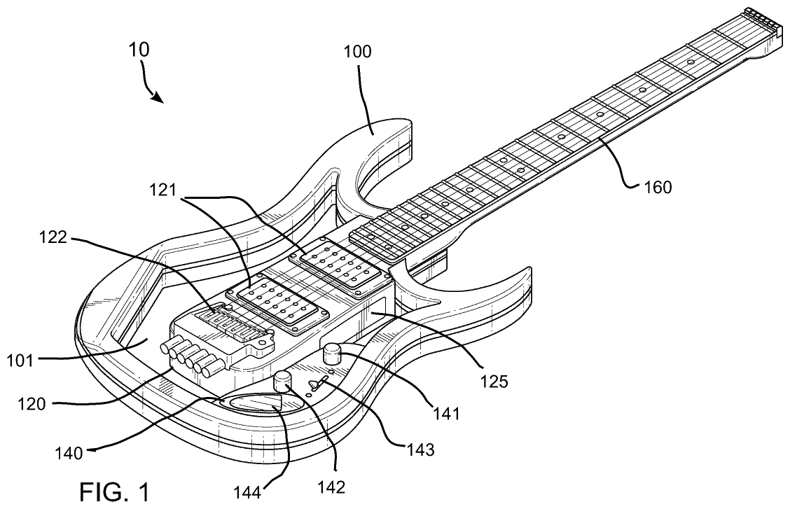

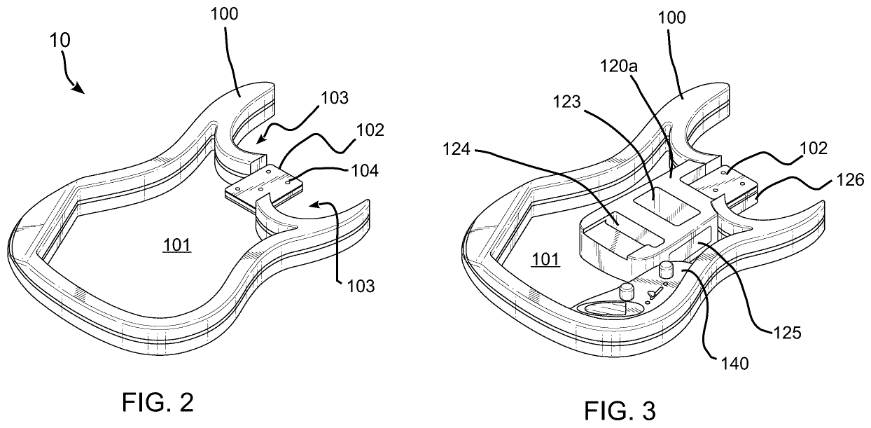

FIG. 1 illustrates one example of a modular electric guitar 10. The guitar 10 includes an outer body 100, shown by itself in FIG. 2, that defines the shape of the guitar as well as an open interior portion 101. In this case, the shape of the outer body 100 is a double- cut design similar to a Stratocaster® or S-style electric guitar shape-but it could be almost any shape that defines an open or empty interior portion.

The open interior 101 is provided for the removable coupling of one or more inner bodies or modules with the outer body 100 such that, when combined, the inner and outer bodies form and fulfill all the roles of a traditional electric guitar body. In this example, an inner body 120 is fitted with pickups 121 and a bridge 122 and is removably coupled to the outer body 100 at the neck end, and a control module 140 is removably coupled to the outer body at the lower bout area. The electronic pickups 121 are in the appropriate position and orientation in correspondence with the guitar strings, and the bridge assembly 122 is in the appropriate position and orientation for retaining and securing the guitar strings in proper position, in this “headless” configuration for the bridge and tuners.

Referring now to FIG. 2, the extent of the empty interior portion 101 within the outer body 100 is shown. Further, the outer body 100 includes a mounting plate 102 provided at the neck end between the double-cut portions 103 for attaching (and removing) a guitar neck 160 (see FIG. 1) and the inner body 120. The mounting plate 102 includes through holes 104 for bolting the combination of the neck 160 and inner body 120 onto the outer body 100, and must provide sufficient structural rigidity in addition to proper positioning in order to enable the guitar to function properly, with appropriate action and intonation when strung.

FIG. 3 illustrates inner body 120a and control module 140 both coupled with the outer body 100. The inner body 120a in this example has a single cutout 123 for receiving a pickup, and a second cutout or recess 124 for receiving and attaching a bridge. A third cutout 125 is located on the side of the inner body and extends to the pickup cutout 123 for providing electrical connections in well-known manner, either as wire nut connections or a standard connector, from the pickup(s) to the control module 140. The inner body 120a also includes a mounting plate 126 extending to the neck area for coupling the inner body with the mount 102 of the outer body 100 and the neck in bolt-on manner, shown assembled in FIG. 1.

As further shown in FIG. 1, electronic pickups 121 are installed in corresponding cavities of the inner body in appropriate position and desired orientation in correspondence with the guitar strings, as well as a bridge assembly 122 for retaining and securing guitar strings in proper position, including in this “headless” configuration of bridge/tuners.

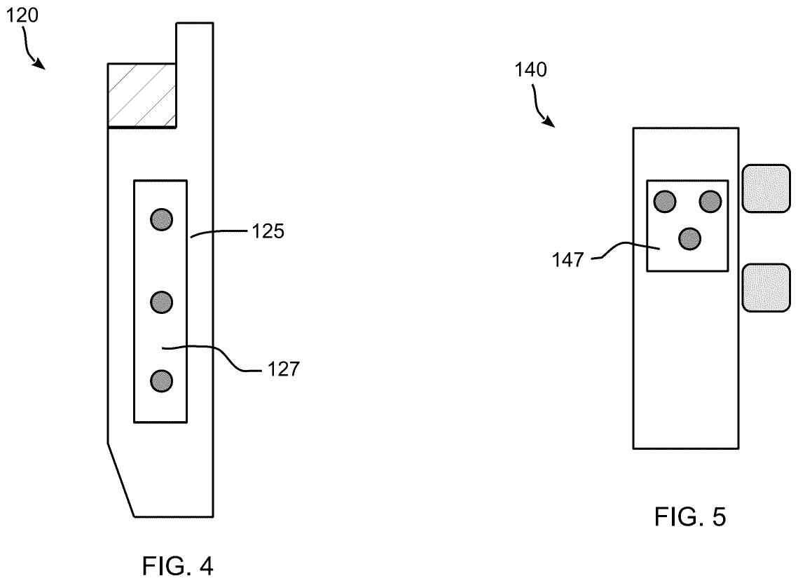

FIG. 4 is a side view of inner body 120 illustrating the use of a three-terminal connector 127 affixed within the cutout 125 and electrically connected with the pickups 121 in this particular configuration. Other configurations or connections may of course be used.

Referring back to FIGS. 1 and 3, the control module 140 includes typical controls such as volume knob 141, tone knob 142, and pickup selector switch 143 on the top surface of the module, which is electrically coupled to the inner body 120. For example, FIG. 5 illustrates a standard three-terminal connector provided on the side of control module 140. An input jack 144 is provided for a standard ¼ inch plug connector.

The examples described above are merely illustrative and not intended to be limiting.

1. A modular electronic instrument, comprising:
an outer body defining an open interior space and having a platform extending from a neck end of the outer body;
a neck configured for removable coupling with the platform of the outer body and extending therefrom; and
an inner body configured for removable coupling with the platform of the outer body and extending into the open interior space of the outer body in alignment with a coupled neck, the inner body further configured for having electronic pickups and controls for the electronic pickups.

2. The modular instrument of claim 1, further comprising:
a control module removably coupled with the outer body within the interior space of the outer body and having the controls for the electronic pickups, and an input jack for an electronic instrument cable.

3. The modular instrument of claim 1, the pickup assembly further comprising:
a first cavity formed in the inner body configured for receiving a bridge; and
a second cavity formed in the inner body for receiving an electronic pickup.

4. The modular instrument of claim 1, the pickup assembly further comprising:
a first cavity formed in the inner body configured for receiving a bridge; and
a plurality of cavities formed in the inner body for receiving corresponding electronic pickups.

5. A modular electric guitar body, comprising
an outer body defining an open interior space and having a neck end and a neck platform extending from the neck end; and
an inner body configured for removable coupling with the platform of the outer body, the inner body extending into the open interior space and having a plurality of cavities formed for receiving a bridge and one or more electronic pickups.

6. The modular electric guitar body of claim 5, comprising:
a control module removably coupled within the interior space of the outer body and having the controls for the electronic pickups, and an input jack for an electronic instrument cable.

7. The modular electric guitar body of claim 5, the pickup assembly further comprising:
a first cavity of the plurality of cavities is formed in the inner body and configured for receiving the bridge; and
one or more of the plurality of cavities are formed in the inner body and configured for receiving corresponding electronic pickups.

8. A method for constructing a modular guitar body, comprising:
forming an outer body to define an open interior space with a platform extending from the outer body and configured for attaching a guitar neck; and
forming an inner body for receiving a bridge, one or more electronic pickups, and controls for the electronic pickups, the inner body configured for attaching to the platform of the outer body.

9. The method of claim 8, further comprising:
forming a plurality of modules configured for attachment to the outer body, including a first module configured for receiving a bridge and one or more electronic pickups and for attachment to the platform, and a second module configured with controls for the electronic pickups.
